(19) United States
(12) Patent Application Publication
(10) Pub. No.: US 2019/0037433 A1
(43) Pub. Date: Jan. 31, 2019

(54) COMMUNICATION METHOD, PROCESSOR, AND USER EQUIPMENT

(71) Applicant: KYOCERA CORPORATION, Kyoto (JP)

(72) Inventors: Yushi NAGASAKA, Ritto-shi (JP); Masato FUJISHIRO, Yokohama-shi (JP); Kugo MORITA, Yokohama-shi (JP); Henry CHANG, San Diego, CA (US)

(73) Assignee: KYOCERA CORPORATION, Kyoto (JP)

(21) Appl. No.: 16/144,893

(22) Filed: Sep. 27, 2018

Related U.S. Application Data
(63) Continuation of application No. PCT/JP2017/011819, filed on Mar. 23, 2017.
(60) Provisional application No. 62/316,739, filed on Apr. 1, 2016.
(60) Provisional application No. 62/335,902, filed on May 13, 2016.

(51) Int. Cl. H04W 28/02

(52) U.S. Cl. CPC H04W 28/0252; H04W 88/06

(57) ABSTRACT

In a communication method according to one embodiment, a base station in a LTE system transmits to a user equipment, configuration information configuring an LTE-WLAN Aggregation (LWA) bearer using both radio resources of the LTE system and radio resource of a WLAN system. The configuration information includes first information indicating a threshold value for an amount of data. The user equipment configures the LWA bearer based on the configuration information. The user equipment transmits, in response to an amount of data belonging to the LWA bearer being equal to or more than the threshold value, the data by using the radio resources of both the LTE system and the WLAN system. The user equipment transmits, in response to the amount of data belonging to the LWA bearer being below the threshold value, the data by using the radio resource of either the LTE system or the WLAN system.

### CROSS-REFERENCE TO RELATED APPLICATION

The present application is a continuation based on PCT Application No. PCT/JP2017/011819 filed on Mar. 23, 2017, which claims the benefit of U.S. Provisional Application No. 62/316,739 (filed on Apr. 1, 2016) and the U.S. Provisional Application No. 62/335,902 (filed on May 13, 2016). The content of which are incorporated by reference herein in their entirety.

### FIELD

The present application relates to a communication method, a processor, and a user equipment.

### BACKGROUND

In LTE (Long Term Evolution) of which the specifications are designed in 3GPP (3rd Generation Partnership Project), which is a project aiming to standardize a cellular communication technology, LWA (LTE-WLAN Aggregation) is introduced (see Non Patent Document 1).

In the LWA, user equipments can utilize not only radio resources of LTE (a cellular communication system) but also radio resources of WLAN (Wireless LAN (Local Area Network): a WLAN communication system). In the LWA, data (packet) is transmitted from a base station to a user equipment via a WLAN termination device (WT: WLAN Termination).

### SUMMARY

In a communication method according to one embodiment, a base station in a Long Term Evolution (LTE) system configures for a user equipment, LTE-WLAN Aggregation (LWA) for utilizing radio resources of the LTE system and a Wireless Local Area Network (WLAN) system by the user equipment. The user equipment executes, in response to a transmission data amount in the user equipment being equal to or more than a threshold value, a first control for transmitting data to both the LTE system and the WLAN system. The user equipment executes, in response to the transmission data amount being below the threshold value, a second control for transmitting the data to either the LTE system or the WLAN system.

A processor according to one embodiment is a processor for controlling a user equipment. The processor executes: a process in which the user equipment is configured, by a base station in a Long Term Evolution (LTE) system, with LTE-WLAN Aggregation (LWA) for utilizing radio resources of the LTE system and a Wireless Local Area Network (WLAN) system by the user equipment; a process in which in response to a transmission data amount in the user equipment being equal to or more than a threshold value, a first control is executed for transmitting data to both the LTE system and the WLAN system; and a process in which in response to the transmission data amount being below the threshold value, a second control is executed for transmitting the data to either the LTE system or the WLAN system.

A user equipment according to one embodiment comprises a controller. The controller is configured to: be configured, by a base station in a Long Term Evolution (LTE) system, with LTE-WLAN Aggregation (LWA) for utilizing radio resources of the LTE system and a Wireless Local Area Network (WLAN) system by the user equipment; execute, in response to a transmission data amount in the user equipment being equal to or more than a threshold value, a first control for transmitting data to both the LTE system and the WLAN system; and execute, in response to the transmission data amount being below the threshold value, a second control for transmitting the data to either the LTE system or the WLAN system.

### BRIEF DESCRIPTION OF THE DRAWINGS

FIG. 1 is a diagram illustrating a system configuration.

FIG. 2 is a protocol stack diagram of a radio interface in an LTE system.

FIG. 3 is a diagram illustrating a radio protocol architecture of an eNB used in LWA.

FIG. 4 is a block diagram illustrating a UE 100.

FIG. 5 is a block diagram illustrating an eNB 200.

FIG. 6 is a block diagram illustrating an AP 300.

FIG. 7 is a block diagram illustrating a WT 600.

FIG. 8 is a diagram for describing a flow of uplink data through the LWA.

FIG. 9 is a sequence diagram for describing an operation according to a first embodiment.

FIG. 10 is a sequence diagram for describing an operation according to a second embodiment.

FIG. 11 is a sequence diagram for describing an operation according to a third embodiment.

FIG. 12 is a diagram for describing an operation according to a modification of a fifth embodiment.

### DESCRIPTION OF THE EMBODIMENT

### Overview of Embodiment

In a communication method according to one embodiment, a base station in a Long Term Evolution (LTE) system configures, for a user equipment, LTE-WLAN Aggregation (LWA) for utilizing radio resources of the LTE system and a Wireless Local Area Network (WLAN) system by the user equipment. The user equipment, in response to a transmission data amount in the user equipment being equal to or more than a threshold value, executes a first control for transmitting data to both the LTE system and the WLAN system. The user equipment, in response to the transmission data amount being below the threshold value, executes a second control for transmitting the data to either the LTE system or the WLAN system.

The base station may, in the configuration, configure the threshold value for the user equipment.

The base station may, in the configuration, transmit, to the user equipment, information for designating whether or not to transmit the data to the WLAN system. The user equipment may, based on the information, transmit the data to either the LTE system or the WLAN system.

The information may indicate that the data is to be transmitted to the WLAN system. The user equipment may, based on the information, transmit the data to the WLAN system. The user equipment may, in a case that the data is transmitted only to the WLAN system, indicate to a Medium Access Control (MAC) entity of the user equipment that the amount of the transmission data is zero.

The user equipment may, in a case that the first control is being executed, transmit, to the base station, a buffer status report based on only the data amount to be transmitted to the LTE system out of the transmission data amount.

A processor according to one embodiment is a processor for controlling a user equipment. The processor executes: a process in which the user equipment is configured, by a base station in a Long Term Evolution (LTE) system, with LTE-WLAN Aggregation (LWA) for utilizing radio resources of the LTE system and a Wireless Local Area Network (WLAN) system by the user equipment; a process in which a first control is executed for transmitting data to both the LTE system and the WLAN system in response to a transmission data amount in the user equipment being equal to or more than a threshold value; and a process in which a second control is executed for transmitting the data to either the LTE system or the WLAN system in response to a fact that the transmission data amount is below the threshold value.

A user equipment according to one embodiment includes a controller. The controller is configured to: be configured, by a base station in a Long Term Evolution (LTE) system, with LTE-WLAN Aggregation (LWA) for utilizing radio resources of the LTE system and a Wireless Local Area Network (WLAN) system by the user equipment; execute a first control for transmitting data to both the LTE system and the WLAN system in response to a transmission data amount in the user equipment being equal to or more than a threshold value; and execute a second control for transmitting the data to either the LTE system or the WLAN system in response to the transmission data amount being below the threshold value.

A base station according to one embodiment includes a controller configured to execute a control for receiving data from a user equipment via a wireless LAN through LTE-WLAN Aggregation (LWA). The controller executes a control for transmitting, to the user equipment, information for designating data to be transmitted by the user equipment by using a radio resource of the base station.

The controller may, in accordance with a reception status of data received via the wireless LAN, execute a control for transmitting the information to the user equipment.

The information may include information for designating a sequence number of the data to be transmitted.

The information may include information for designating a transmission time of the data to be transmitted.

A base station according to one embodiment includes a controller configured to execute a control for receiving data from a user equipment via a wireless LAN through LTE-WLAN Aggregation (LWA). The controller informs the user equipment of a reception status of the data.

The controller may inform the user equipment of a reception status of the data before the user equipment executes a handover to another base station.

A base station according to one embodiment includes a controller configured to execute a control for receiving data from a user equipment via at least one of LTE and wireless LAN through LTE-WLAN Aggregation (LWA).

The controller executes a control for receiving the data transmitted by using a radio resource of the base station, via the LTE, and a control for receiving the data transmitted by using a radio resource of the wireless LAN, via the wireless LAN. The controller executes a control for transmitting, to the user equipment, a PDCP PDU for designating whether to transmit the data via the LTE or via the wireless LAN.

A user equipment according to one embodiment includes a controller configured to execute a control for transmitting data to a base station via a wireless LAN through LTE-WLAN Aggregation (LWA). The controller executes, in accordance with the communication status of data via the wireless LAN, a control for transmitting a buffer status report to the base station.

The controller may execute a control for transmitting, to the base station, information about a communication status of data via the wireless LAN.

The controller may, until a predetermined time elapses, execute a control for transmitting data by using only a radio resource of the base station without transmitting data via the wireless LAN.

The controller may execute a control for receiving, from the base station, information for determining to transmit data by using only a radio resource of the base station.

The controller may execute a control for receiving, from the base station, information about a reception status of data via the wireless LAN in the base station.

A user equipment according to one embodiment includes a controller configured to execute a control for transmitting data to a first cell via a wireless LAN through LTE-WLAN Aggregation (LWA). The controller executes a control for executing a handover from the first cell to a second cell. The controller, in response to a transmission status of data via the wireless LAN that a WLAN entity of the user equipment transmits to a PDCP entity of the user equipment, decides data to be transmitted to the second cell.

A user equipment according to one embodiment includes a controller configured to execute a control for transmitting data to a base station via at least one of LTE and wireless LAN through LTE-WLAN Aggregation (LWA). The controller executes a control for transmitting the data by using a radio resource of the base station, via the LTE, and a control for transmitting the data by using a radio resource of the wireless LAN, via the wireless LAN. The controller executes a control for transmitting a first data via one of the LTE and the wireless LAN, and transmitting a second data following the first data via the other one of the LTE and the wireless LAN. The second data includes information about a transmission time of the second data.

A user equipment according to one embodiment includes a controller configured to execute a control for transmitting data to a base station via at least one of LTE and wireless LAN through LTE-WLAN Aggregation (LWA). The controller executes a control for transmitting the data by using a radio resource of the base station, via the LTE, and a control for transmitting the data by using a radio resource of the wireless LAN, via the wireless LAN. The controller executes a control for transmitting, if an amount of the transmission data in a PDCP entity is below a first threshold value, the data only via one of the LTE and the wireless LAN.

The controller may, in a case that the data is transmitted only via the wireless LAN, execute a control for informing that the data does not exist in a MAC entity of the user equipment even though the data exists.

The controller may, in a case that the data is transmitted only via the LTE, execute a control for informing that the data does not exist in a WLAN entity of the user equipment even though the data exists.

The controller may further execute a control for transmitting data to at least one of the base station that is the master base station, and a secondary base station configured to transfer data from the user equipment to the maser base station, by Dual Connectivity (DC). The controller may control the transmission of data by using not only the first threshold value, but also the second threshold value. The controller may, if the amount of the transmission data is below a second threshold value, execute a control for transmitting the data to only one of the master base station and the secondary base station.

A user equipment according to one embodiment may include a controller configured to execute a control for transmitting data to a base station through LTE-WLAN Aggregation (LWA) via at least one of LTE and wireless LAN. The controller may execute a control for transmitting the data by using a radio resource of the base station, via the LTE, and a control for transmitting the data by using a radio resource of the wireless LAN, via the wireless LAN. The controller may execute a control for informing, by a PDCP entity of the user equipment, a WLAN entity of the user equipment of an amount of the transmission data in the PDCP entity.

The controller may, when the controller transmits a buffer status report to a base station, execute a control for also informing the WLAN entity of the amount of the transmission data.

The controller may, in response to an inquiry from the WLAN entity to the PDCP entity, execute a control for informing the WLAN entity of the amount of the transmission data.

A case in which an LTE system, which is a cellular communication system configured in compliance with the 3GPP standards, can be in cooperation with a wireless LAN (WLAN: Wireless Local Area Network) system will be exemplified and described below with reference to drawings.

(System Configuration)

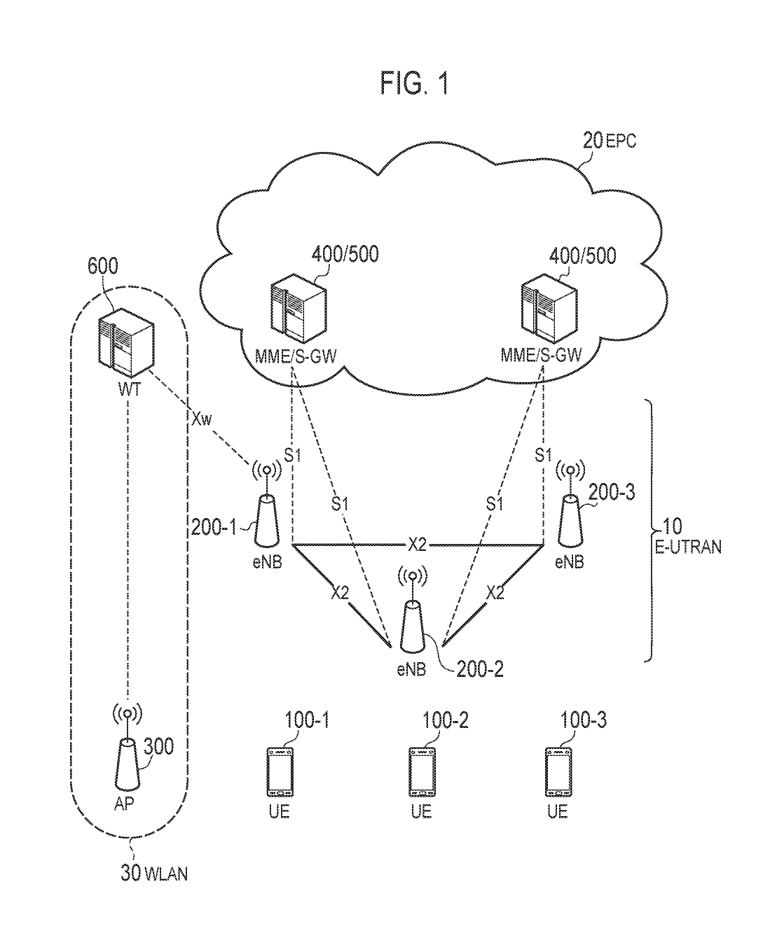

FIG. 1 is a system configuration diagram according to an embodiment. As illustrated in FIG. 1, a cellular communication system includes a plurality of UEs (User Equipments) 100, an E-UTRAN (Evolved-UMTS Terrestrial Radio Access Network) 10, and an EPC (Evolved Packet Core) 20.

The E-UTRAN 10 corresponds to a cellular radio access network (RAN). The EPC 20 corresponds to a core network. The E-UTRAN 10 and the EPC 20 constitute a network of the LTE system.

UE 100 is a user apparatus (radio terminal). The UE 100 is a mobile radio communication apparatus. The UE 100 is a terminal (dual terminal) supporting both communication methods of cellular communication and WLAN communication.

The E-UTRAN 10 includes a plurality of eNBs 200 (evolved Nodes-B). The eNB 200 corresponds to a base station. The eNB 200 manages one or a plurality of cells. The eNB 200 performs radio communication with the UE 100 with which a connection is established with a cell of the eNB 200. It is noted that the “cell” is used as a term indicating a minimum unit of a radio communication area. The “cell” may be also used as a term indicating a function of performing radio communication with the UE 100. Further, the eNB 200 has a radio resource management (RRM) function, a routing function of user data, and a measurement control function for mobility control and scheduling, for example.

The eNBs 200 are connected with one another via an X2 interface. Further, the eNB 200 is connected via an S1 interface to an MME (Mobility Management Entity) 400 and an SGW (Serving-Gateway) 500 included in the EPC 20. The eNB 200 is connected to the WT 600 described later via an Xw interface.

The EPC 20 includes a plurality of MMEs (Mobility Management Entities) 400/SGWs (Serving-Gateways) 500. The MME 400 is a network node that performs various mobility controls, etc., on the UE 100, and corresponds to a controller. The SGW 500 is a network node that performs control to transfer user data, and corresponds to a switching center.

The WLAN 30 includes a WLAN access point (hereinafter referred to as “AP”) 300 and a WLAN terminating apparatus (hereinafter referred to as “WT”) 600. The AP 300 is, for example, an AP (Operator controlled AP) managed by an NW (Network) operator of the LTE system.

The WT 600 is a logical node. The WT 600 is connected to the eNB 200 via the Xw interface. The WT 600 terminates the Xw interface with respect to the WLAN. The Xw interface is constituted of an Xw user plane interface (Xw-U) and an Xw control plane interface (Xw-C). Xw-U is used to carry data (LWA PDU) between the eNB 200 and the WT 600. Xw-C is used to carry control signals between the eNB 200 and the WT 600.

The WT 600 is associated with one or more APs 300. The WT 600 transmits or receives data to the UE 100 via the associated APs 300. The WT 600 holds the identifier of the associated AP 300.

The WLAN 30 is configured in conformity with, for example, IEEE 802.11 standards. The AP 300 performs WLAN communication with the UE 100 in a frequency band different from the cellular frequency band. Generally, WLAN communication is performed in unlicensed band. Cellular communication is performed in a licensed band. The AP 300 is connected to the EPC 20 via a router or the like.

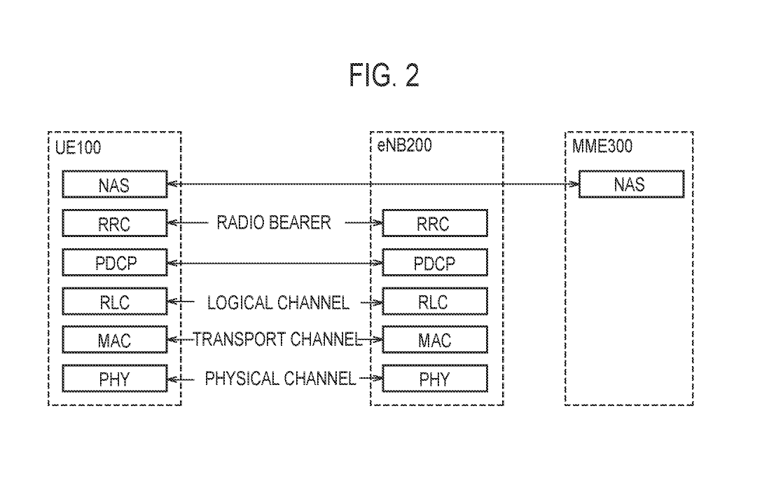

FIG. 2 is a protocol stack diagram of a radio interface in the cellular communication system. As illustrated in FIG. 2, the radio interface protocol is classified into a layer 1 to a layer 3 of an OSI reference model. The layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer (PHY entity) performs encoding and decoding, modulation and demodulation, antenna mapping and demapping, and resource mapping and demapping. Between the PHY layer of the UE 100 and the PHY layer of the eNB 200, user data and control signal are transmitted via the physical channel.

The MAC layer (MAC entity) performs preferential control of data, and a retransmission process by hybrid ARQ (HARQ), a random access procedure and the like. Between the MAC layer of the UE 100 and the MAC layer of the eNB 200, data is transmitted via a transport channel. The MAC layer of the eNB 200 includes a scheduler. The scheduler decides a transport format (a transport block size, a modulation and coding scheme, and the like) of an uplink and a downlink, and an assigned resource block.

The RLC layer (RRC entity) transmits data to an RLC layer of a reception side by using the functions of the MAC layer and the PHY layer. Between the RLC layer of the UE 100 and the RLC layer of the eNB 200, data is transmitted via a logical channel.

The PDCP layer (PDCP entity) performs header compression and decompression, and encryption and decryption.

The RRC layer (RRC entity) is defined only in a control plane. Between the RRC layer of the UE 100 and the RRC layer of the eNB 200, a message (an RRC message) for various types of setting is transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in a connected state (connected state). Otherwise, the UE 100 is in an idle state (idle state).

A NAS (Non-Access Stratum) layer positioned above the RRC layer performs session management or mobility management, for example. The MME 300 exchange NAS massages with the UE 100.

(LWA)

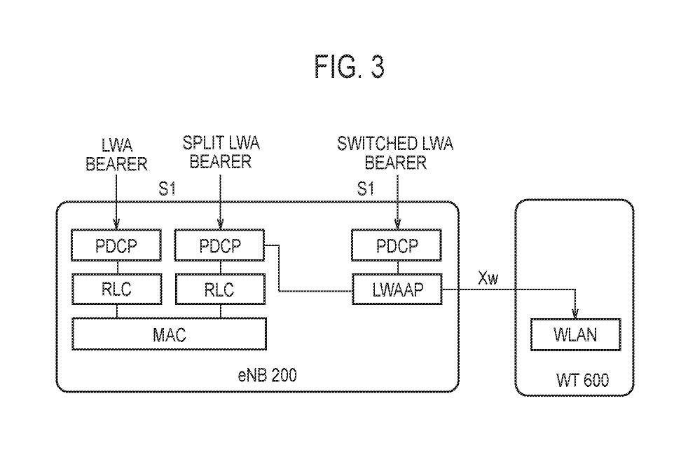

LWA (LTE-WLAN Aggregation) will be described by using FIG. 3. FIG. 3 illustrates a radio protocol architecture of an eNB 200 used in the LWA.

The E-UTRAN 10 supports an LWA operation. In the LWA, to use radio resources of LTE and WLAN, a UE 100 in an RRC connected state is configured by the eNB 200.

As illustrated in FIG. 3, in the LWA, an LWAAP (LTE-WLAN Aggregation Adaptation Protocol) entity is arranged in the eNB 200. The LWAAP entity generates an LWA PDU. The LWA PDU is a PDU (Protocol Data Unit) including a DRB (Data Radio Bearer) identifier (DRB ID) generated through the LWAAP entity for transmission via the WLAN 30 in the LWA. The WT 600 uses LWA EtherType for transferring data to the UE 100 via the WLAN 30. The UE 100, to decide that the received PDU belongs to the LWA bearer, uses the LWA EtherType. The UE 100 uses the DRB identifier to decide an LWA bearer to which the PDU belongs.

In the LWA, there exists a bearer (an LWA bearer) in which data (packet) is transmitted by using only a radio resource of the eNB 200 (LTE).

The LWA has two types of bearers. The two types of bearers include a split LWA bearer and a switched LWA bearer.

The split LWA bearer is a bearer in which a radio protocol is located in both the eNB 200 and the WLAN 30 to use radio resources of the eNB 200 and the WLAN 30, in the LWA. The split LWA bearer is a bearer that is split in the PDCP layer. In one split bearer, data is transmitted by using a radio resource of the eNB 200. The data is transmitted via the PDCP layer (a first PDCP layer), the RLC layer, and the MAC layer. In the other split bearer, data is transmitted by using a radio resource of the WLAN 30. The data is transmitted from the PDCP layer to the WT 600 via the LWAAP. The data is transmitted to the UE 100 via the WT 600 and the AP 300.

The switched LWA bearer is a bearer in which a radio protocol is located in both the eNB 200 and the WLAN 30 in the LWA, but only a radio resource of the WLAN 30 is used. In the switched LWA bearer, similarly to the other split bearer described above, the data is transmitted from the PDCP layer (a second PDCP layer) to the WT 600 via the LWAAP.

A case in which the LWA is used for transmission of downlink data (packet) was described, but a case in which the LWA is used for transmission of uplink data (packet) is also similar.

However, a destination (the PDCP layer) of data (packet) transmitted from the UE 100 to the eNB 200 via the WLAN 30 varies depending on a bearer to which the data belongs. The LWAAP decides a PDCP to be transmitted, based on a DRB identifier included in the data (packet). The LWAAP, if the data belongs to the split LWA bearer (that is, the data includes an identifier of the split LWA bearer), sends the data to the first PDCP layer. In the first PDCP layer, the data is combined with data (packet) transmitted from the RLC layer. The first PDCP layer sends the combined data to a high-level node (the MME 400/SGW 500). On the other hand, the LWAAP, if the data belongs to the switched LWA bearer (that is, the data includes an identifier of the switched LWA bearer), sends the data to the second PDCP layer. The second PDCP layer sends the data to a high-level node (the MME 400/SGW 500).

(WLAN Mobility Set)

Next, a WLAN mobility set will be described. The WLAN mobility set is a set of one or more APs 300 to be identified by one or more WLAN identifiers (for example, a BSSID (Basic Service Set ID), an HESSID (Homogenous Extended Service Set ID), an SSID (Service Set ID), etc. The UE 100 may, without notifying the eNB 200, execute mobility among the APs 300 belonging to the WLAN mobility set.

The eNB 200 provides a WLAN mobility set to the UE 100. If a WLAN mobility set is configured for the UE 100, the UE 100 attempts a connection with a WLAN 30 (AP 300) having an identifier that matches with one of the configured WLAN mobility set. The mobility of the UE 100 to an AP 300 not belonging to the WLAN mobility set is controlled by the eNB 200. For example, the eNB 200 updates the WLAN mobility set, based on a measurement report provided by the UE 100. The UE 100 connects with one WLAN mobility set (APs 300) at most at one time. All the APs belonging to the WLAN mobility set share a common WT 600 that terminates the Xw-C and the Xw-U. WLAN identifiers belonging to the WLAN mobility set may be some (a subset) of all WLAN identifiers associated with the WT 600.

(WLAN Measurement Report)

A UE 100 supporting the LWA may be configured by the eNB 200 (E-UTRAN 10) to execute a WLAN measurement report. A WLAN measurement target may be configured by at least one of a WLAN identifier, a WLAN channel number, and a WLAN band.

The WLAN measurement report is triggered by using the received strength (RSSI: Received Signal Strength Indicator) of a radio signal (for example, a beacon signal) from the AP 300. The WLAN measurement report may include an RSSI, channel utilization, a station count, an admission capacity, a backhaul rate, and a WLAN identifier.

(Radio Terminal)

A configuration of the UE 100 (radio terminal) will be described, below. FIG. 3 is a block diagram illustrating the UE 100.

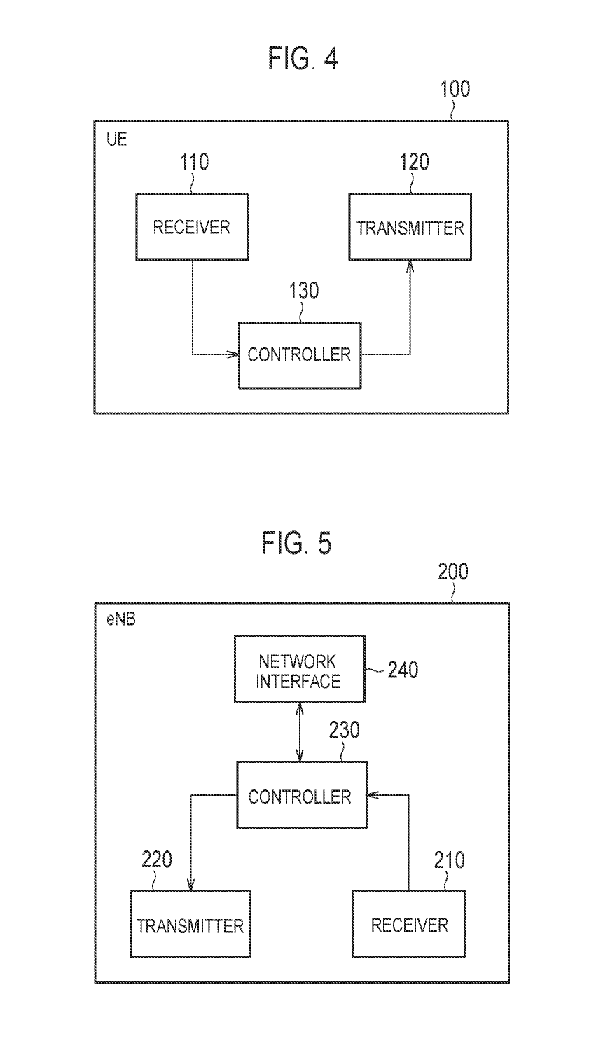

As illustrated in FIG. 4, the UE 100 includes a receiver 110, a transmitter 120, and a controller 130. The receiver 110 and the transmitter 120 may be unified as one in the form of a transceiver. Further, the UE 100 may include a receiver 110 and a transmitter 120 used in common in cellular communication and WLAN communication. The UE 100 may include a receiver 110 and a transmitter 120 for cellular communication. The UE 100 may include a receiver 110 and a transmitter 120 for WLAN communication.

The receiver 110 performs various types of receptions under the control of the controller 130. The receiver 110 includes an antenna. The receiver 110 converts a radio signal received by the antenna into a baseband signal (received signal), and outputs the baseband signal to the controller 130.

The transmitter 120 performs various types of transmissions under the control of the controller 130. The transmitter 120 includes an antenna. The transmitter 120 converts a baseband signal (transmission signal) output from the controller 130 into a radio signal, and transmits the radio signal from the antenna.

The controller 130 performs various types of controls in the UE 100. The controller 130 can control the receiver 101 and the transceiver 102. The controller 130 includes a processor and a memory. The memory stores a program to be executed by the processor, and information to be used for a process by the processor. The processor includes a baseband processor and a CPU (Central Processing Unit). The baseband processor performs modulation and demodulation, encoding and decoding and the like of a baseband signal. The CPU performs various processes by executing the program stored in the memory. The controller 130 executes various types of processes described later, and various types of communication protocols described above.

In the present specification, processing performed by at least one of the receiver 110, the transmitter 120, and the controller 130 of the UE 100 will be described as a process (operation) executed by the UE 100 for the sake of convenience.

(Base Station)

A configuration of the eNB 200 (base station) will be described, below. FIG. 5 is a block diagram illustrating the eNB 200.

As illustrated in FIG. 5, the eNB 200 includes a receiver 210, a transmitter 220, a controller 230, and a network interface 240. The receiver 210 and the transmitter 220 may be unified as one in the form of a transceiver.

The receiver 210 performs various types of receptions under the control of the controller 230. The receiver 210 includes an antenna. The receiver 210 converts a radio signal received by the antenna into a baseband signal (received signal), and outputs the baseband signal to the controller 230.

The transmitter 220 performs various types of transmissions under the control of the controller 230. The transmitter 220 includes an antenna. The transmitter 220 converts a baseband signal (transmission signal) output from the controller 230 into a radio signal, and transmits the radio signal from the antenna.

The controller 230 performs various types of controls in the eNB 200. The controller 230 can control the receiver 210, the transmitter 220, and the network interface 240. The controller 230 includes a processor and a memory. The memory stores a program to be executed by the processor, and information to be used for a process by the processor. The processor includes a baseband processor and a CPU (Central Processing Unit). The baseband processor performs modulation and demodulation, encoding and decoding and the like of a baseband signal. The CPU performs various processes by executing the program stored in the memory. The controller 230 executes various types of processes described later, and various types of communication protocols described above.

The network interface 240 is connected to a neighbour eNB 200 via the X2 interface. The network interface 240 is connected to the MME 400 and SGW 500 via the S1 interface. The network interface 240 is used for communication performed over the X2 interface, communication performed over the S1 interface, and the like.

Further, the network interface 240 is connected to the WT 600 via the Xw interface. The network interface 240 is used for communication performed over the Xw interface, and the like.

In the present specification, processes performed by at least one of the receiver 210, the transmitter 220, the controller 230 and the network interface 240 included in the eNB 200 will be described as processes (operations) executed by the eNB 200 for convenience.

(Wireless LAN Access Point)

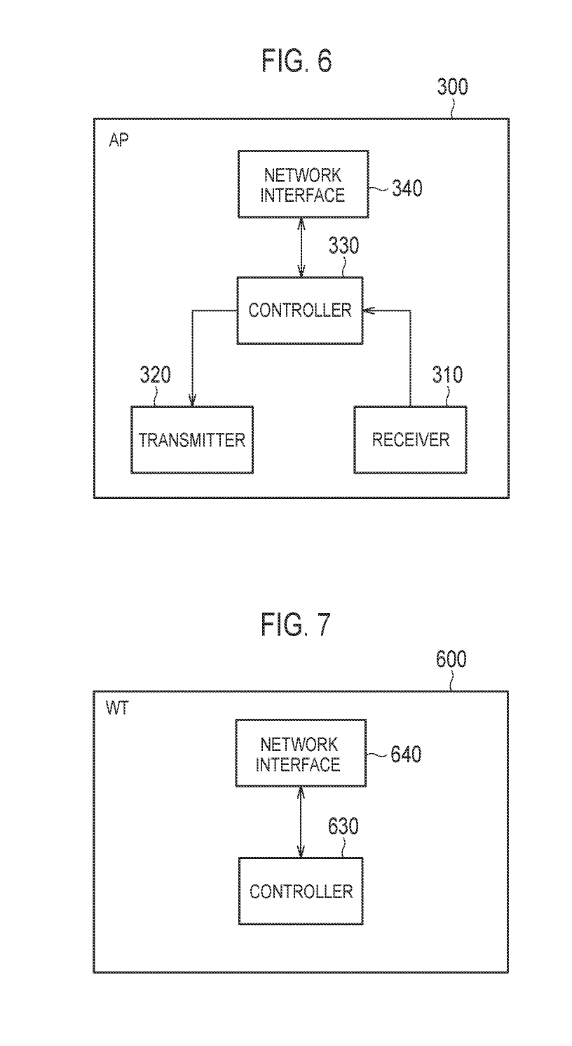

Next, a configuration of the AP 300 (wireless LAN access point) will be described. FIG. 6 is a block diagram illustrating the AP 300.

As illustrated in FIG. 6, the AP 300 includes a receiver 310, a transmitter 320, a controller 330, and a network interface 340. The receiver 310 and the transmitter 320 may be an integrated transceiver.

The receiver 310 performs various types of receptions under the control of the controller 330. The receiver 310 includes an antenna. The receiver 310 converts a radio signal received by the antenna into a baseband signal (received signal), and outputs the baseband signal to the controller 330.

The transmitter 320 performs various types of transmissions under the control of the controller 330. The transmitter 320 includes an antenna. The transmitter 320 converts a baseband signal (transmission signal) output from the controller 330 into a radio signal to be transmitted from the antenna.

The controller 330 performs various types of controls in the AP 300. The controller 330 can control the receiver 310, the transmitter 320, and the network interface 340. The controller 330 includes a processor and a memory. The memory stores a program to be executed by the processor, and information to be used for a process by the processor. The processor includes a baseband processor and a CPU. The baseband processor performs modulation and demodulation, coding and decoding, and the like, of the baseband signal. The CPU executes a program stored in the memory to perform various types of processes. The controller 330 executes various types of processes described later, and various types of communication protocols described above.

The network interface 340 is connected to a backhaul via a predetermined interface. The network interface 340 is connected to the WT 600, and is used for communication with the WT 600, and the like.

For simplicity, a process executed by at least one of the receiver 310, the transmitter 320, the controller 330, and the network interface 340 included in the AP 300 is described herein as a process (operation) executed by the AP 300.

(WLAN Termination Device)

A configuration of the WT 600 (WLAN termination device) will be described. FIG. 7 is a block diagram illustrating the WT 600.

As illustrated in FIG. 7, the WT 600 includes a controller 630 and a network interface 640.

The controller 630 performs various types of controls in the WT 600. The controller 630 can control the network interface 640. The controller 630 includes a processor and a memory. The memory stores a program to be executed by the processor, and information to be used for a process by the processor. The processor includes a baseband processor and a CPU. The baseband processor performs modulation and demodulation, coding and decoding, and the like, of the baseband signal. The CPU executes a program stored in the memory to perform various types of processes. The controller 630 executes various types of processes described later, and various types of communication protocols described above.

The network interface 640 is connected to a backhaul via a predetermined interface. The network interface 640 is connected to the AP 300, and is used for communication with the AP 300, and the like.

The network interface 640 is connected to the eNB 200 via the Xw interface. The network interface 640 is used for communication performed over the Xw interface, and the like.

For simplicity, a process executed by at least one of the controller 630 and the network interface 640 included in the WT 600 is described herein as a process (operation) executed by the WT 600.

### First Embodiment

(Flow of Uplink Data Through the LWA)

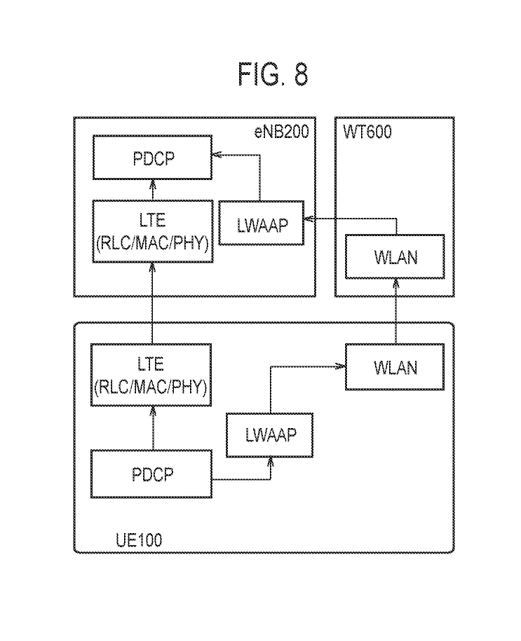

A flow of uplink data through the LWA will be described by using FIG. 8. FIG. 8 is a diagram for describing a flow of uplink data through the LWA.

As illustrated in FIG. 8, the UE 100 can transmit data to the eNB 200 via LTE and WLAN through the LWA. Accordingly, the UE 100 can execute a control for transmitting data via either the LTE or the WLAN. The UE 100 executes a control for transmitting data by using a radio resource of the eNB 200, via the LTE. The UE 100 executes a control for transmitting data by using a radio resource of the WLAN 30 (AP 300), via the WLAN.

The eNB 200 can receive data from the UE 100 via the LTE and the WLAN through the LWA. Accordingly, the eNB 200 can execute a control for receiving data from the UE 100 via at least one of the LTE and the WLAN. The eNB 200 executes a control for receiving the data transmitted by using a radio resource of the eNB 200, via the LTE. The eNB 200 executes a control for receiving the data transmitted by using a radio resource of the WLAN 30 (AP 300), via the WLAN. Specifically, the eNB 200 receives the data from the WT 600 via the Xw interface. The WT 600 receives, from the AP 300, the data from the UE 100.

An example in which the UE 100 transmits data to the eNB 200 through the LWA will be specifically described. Specifically, a flow of data belonging to a split LWA bearer will be described. Hereinafter, in the UE 100, a WLAN function in the LWA will be conveniently called a WLAN entity. The WLAN entity is an entity for transmitting and/or receiving data via the WLAN 30. The RLC entity, the MAC entity, and the PHY entity will be conveniently called an LTE entity.

As illustrated in FIG. 8, in the UE 100, the PDCP of the UE 100 sends data to either the LTE entity or the LWAAP entity. The LWAAP entity is a low-level entity of the PDCP entity.

The LTE entity includes the RLC entity (hereinafter, RLC), the MAC entity (hereinafter, MAC), and the PHY entity (hereinafter, PHY). The data sent from the PDCP is sent to the eNB 200 via the RLC, MAC and PHY by using a radio resource of the eNB 200 (LTE). The data sent to the eNB 200 is sent to the PDCP of the eNB 200 via the LTE entity (PHY, MAC and RLC) of the eNB 200.

The LWAAP entity (hereinafter, LWAAP) sends the data received from the PDCP to the WLAN entity. The WLAN entity includes the WLAN MAC entity (hereinafter, WLAN MAC) and the WLAN PHY entity (hereinafter, WLAN PHY). The data sent from the LWAAP is sent to the WLAN 30 (AP 300 and WT 600) via the WLAN MAC and WLAN PHY by using a radio resource of the WLAN 30.

The data sent to the WLAN 30 is sent to the LWAAP entity (hereinafter, LWAAP) of the eNB 200 via the AP 300 and the WLAN 60 (WLAN of the WT 600). The LWAAP of the eNB 200 sends the data to the PDCP of the eNB 200.

The PDCP of the eNB 200 combines the data (packet) received from the LTE entity of the eNB 200 and the data (packet) received from the LWAAP of the eNB 200. The PDCP of the eNB 200 sends the combined data to a high-level node (for example, the SGW 500).

### Operation According to First Embodiment

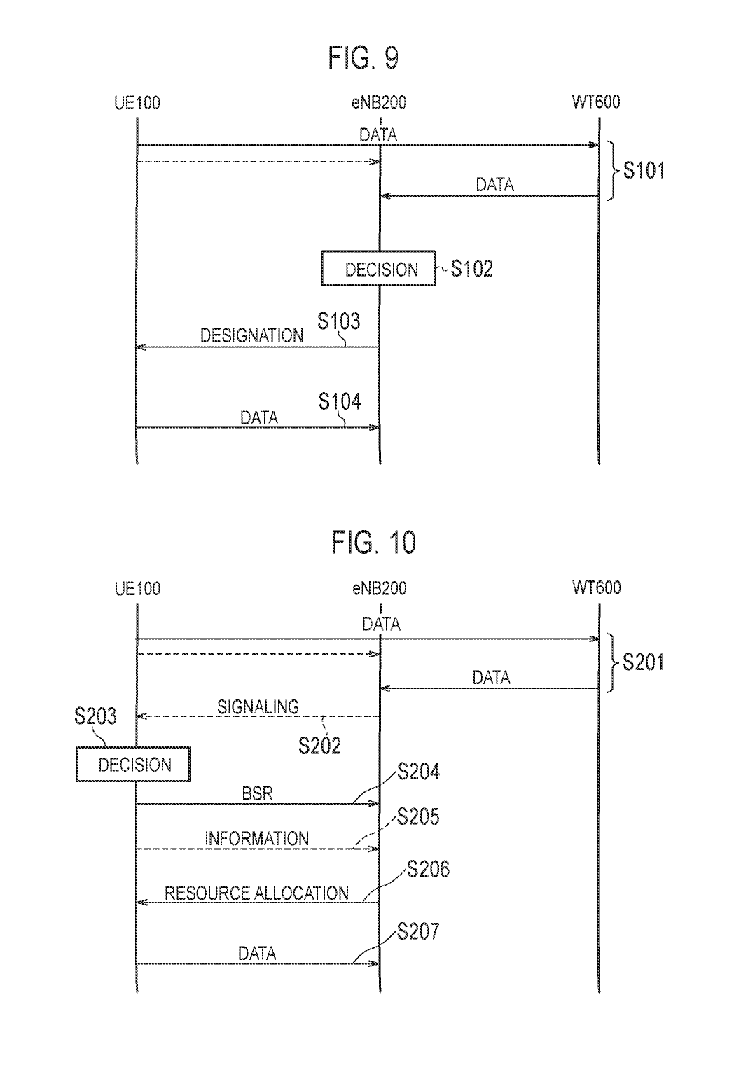

An operation according to a first embodiment will be described by using FIG. 9. FIG. 9 is a sequence diagram for describing an operation according to the first embodiment.

In FIG. 9, a split LWA bearer is configured, by the eNB 200, for the UE 100. The split LWA bearer is established between the UE 100 and the eNB 200.

As illustrated in FIG. 9, in step S101, the UE 100 sends data to the eNB 200, through the LWA, via the WLAN 30. The UE 100 sends data to the WT 600. The WT 600 sends (transfers) data to the eNB 200 via the Xw interface. The UE 100 may directly send the data to the eNB 200.

In step S102, the eNB 200, in accordance with the reception status of data via the WLAN 30, can determine whether or not to execute a process in step S103.

The eNB 200 may, if the data via the WLAN 30 (the data from the WT 600) is delayed, execute the process in step S103.

In step S103, the eNB 200 transmits, to the UE 100, designation information (DESIGNATION) for designating whether to transmit the data via LTE or via the WLAN 30. Accordingly, the eNB 200 can designate a network (LTE/WLAN 30) to which the data is transmitted, in the LWA.

The eNB 200 may, in accordance with the reception status of the data via the WLAN 30, execute a control for transmitting the designation information to the UE 100. The eNB 200 may, if the reception status of the data via the WLAN 30 has deteriorated, transmit, to the UE 100, designation information for designating that the UE 100 transmits data via the LTE. The eNB 200 may, if the reception status of the data via the WLAN 30 has improved, transmit, to the UE 100, designation information for designating that the UE 100 transmits the data via the WLAN 30.

The eNB 200 may, if the data via the WLAN 30 (hereinafter, appropriately called the WLAN data) is delayed, execute the process in step S103. For example, the eNB 200, if data via the LTE in which an SN (Sequence Number) value is 1, 2, 3, 9, 10, . . . (hereinafter, appropriately called LTE data) is received from the UE 100, determines that the WLAN data with the SN value being 4 to 8 is delayed. The eNB 200 may, if a difference between the maximum SN value of the LTE data and the minimum SN value of the WLAN data to be received is equal to or larger than a threshold value, determine that the WLAN data is delayed.

The eNB 200 may, as described later, determine a delay in the WLAN data, based on a buffer status report (BSR) from the UE 100 (see S204 in a second embodiment). The eNB 200 may, based on the communication status of the WLAN data of the UE 100, determine a delay in the WLAN data (see S205 in the second embodiment). The eNB 200 may, based on information about the transmission time included in the WLAN data (packet), determine a delay in the WLAN data (see a fourth embodiment).

The eNB 200 may transmit the designation information to the UE 100 by an RRC Connection Reconfiguration message.

The eNB 200 may transmit the designation information to the UE 100 by a PDCP PDU (PDCP Protocol Data Unit). The PDCP PDU may be a control PDU and a data PDU. The PDCP PDU may be a PDU indicating a PDCP status report. A reserved bit in the PDCP PDU may represent the designation information.

The designation information is information for designating (indicating) that the UE 100 transmits the data only via the LTE, or information for designating (indicating) that the UE 100 transmits the data only via the WLAN 30.

If a transmission data amount of the UE 100 is below a threshold value, a case in which the UE 100 transmits data only via the WLAN (or via the LTE) is assumed. In this case, the designation information may be information for setting a threshold value to be compared with the transmission data amount (for example, the transmission data amount in the PDCP) to be a predetermined value or higher. The designation information, for example, may be information for configuring the threshold value to 0 (or infinity).

The designation information may include information for designating an SN value (a sequence number) of the data to be transmitted. The UE 100 transmits data only via the LTE (or via the WLAN) up to the designated SN value. The information may be included in the RRC Connection Reconfiguration message, or may be included in the PDCP PDU.

The designation information may include information (for example, bit array) for designating a direct value of the SN value of the data. The designation information may include information for designating a range of the SN value of the data (SN#m to SN#n). The SN value may include the SN value of the data that has already been transmitted by the UE 100. Accordingly, the UE 100 may, in accordance with the designation information, re-transmit the data that has already been transmitted via the WLAN (or via the LTE).

The designation information may include information for designating a transmission time of data to be transmitted. The designation information may be information for designating a time period (time) when the UE 100 transmits data only via the LTE (or via the WLAN 30). The UE 100 transmits data only via the LTE (or via the WLAN 30) by the designated time. The designated information may be information on a timer for counting a time period when the UE 100 transmits data only via the LTE (or via the WLAN 30). The UE 100 transmits data only via the LTE (or via the WLAN 30) until the timer expires. Accordingly, the UE 100 executes a control for transmitting data by using only a radio resource of the eNB 200 without transmitting data via the WLAN 30 until a predetermined time elapses. Alternatively, the UE 100 may, until a predetermined time elapses, execute a control for transmitting data by using only a radio resource of the WLAN 30 (AP 300) without transmitting data via the LTE. The time information may be included in the RRC Connection Reconfiguration message, or may be included in the PDCP PDU.

The designation information may be information for designating (indicating) that the UE 100 transmits data via the LTE and via the WLAN 30. As a result, the UE 100 which is designated (indicated) to transmit data only via the LTE (or via the WLAN 30) can start data transmission via the LTE and via the WLAN 30 based on the designation information.

Hereinafter, it is assumed that the eNB 200 transmits, to the UE 100, the designation information for designating the UE 100 to transmit data only via the LTE.

In step S104, the UE 100, in accordance with the designation information, transmits data only via the LTE.

From the above, if an LWA operation is being executed, the eNB 200 can designate the transmission path of the data of the UE 100. As a result of a delay in the WLAN data in the eNB 200, a difference occurs between the hyper frame number (HFN) of the data received by the eNB 200, and the HFN of the data transmitted by the UE 100, and an HFN non-synchronization may occur. In such a case, the eNB 200 can, by appropriately designating the data transmission path of the UE 100, restrain to generate HFN non-synchronization while effectively utilizing resources.

The HFN (that is, the overflow counter mechanism) is used between the eNB 200 and the UE 100 for restricting the actual number of sequence number bits that must be sent wirelessly.

### Second Embodiment

An operation according to a second embodiment will be described by using FIG. 10. FIG. 10 is a sequence diagram for describing the operation according to the second embodiment. It should be noted that the description of portions similar to those in the above-described embodiment will be omitted.

In the second embodiment, the transmission path is switched in the LWA at the initiative of a UE.

In FIG. 10, step S201 corresponds to step S101.

In step S202, the eNB 200 may, by transmitting signaling to the UE 100, inform the UE 100 of the reception status of data via the WLAN 30 (hereinafter, the WLAN reception status) in the eNB 200.

The eNB 200 may periodically inform the UE 100 of the WLAN reception status. The eNB 200 may, in accordance with the WLAN reception status, inform the UE 100 of the WLAN reception status. The eNB 200 may, if the reception status of data via the WLAN 30 has deteriorated, inform the UE 100 of the WLAN reception status.

The eNB 200 may inform the UE 100 of the WLAN reception status in the RRC. For example, the eNB 200 may inform the UE 100, by an RRC message, of the maximum SN value of the data (the successful packet) that was successfully received via the WLAN 30. Thus, the RRC of the eNB 200 may inform the UE 100 of the maximum SN value of the successful packet, in the RRC of the UE 100.

The eNB 200 may inform the UE 100 of the WLAN reception status in the PDCP. For example, the eNB 200 may inform the UE 100, by a PDCP PDU (for example, a PDCP status report), of the maximum SN value of the data (the successful packet) that was successfully received via the WLAN 30. For example, the PDCP of the eNB 200 may inform the UE 100 of the maximum SN value of the successful packet, in the PDCP of the UE 100.

The eNB 200 may inform the UE 100 of not only the WLAN reception status, but also the reception status of the data via the LTE.

In step S203, the UE 100, in accordance with the communication status of data via the WLAN 30, can determine whether or not to execute the process in step S204.

The UE 100 may, in accordance with the transmission status of data via the WLAN 30, determine whether or not to execute the process in step S204. For example, the UE 100 may, in accordance with the WLAN reception status (the signaling in S202) in the eNB 200 notified from the eNB 200, determine whether or not to execute the process in step S204. Thus, the UE 100 may, if a delay occurs in the transmission data from the UE 100 to the eNB 200 via the WLAN 30, determine that the process in step S204 is to be executed.

The UE 100 may, based on a timer for measuring the delay in the transmission data, determine whether or not to execute the process in step S204. The UE 100 may, if the timer has expired, determine that the process in step S204 is to be executed. The UE 100 may, if the transmission of data via the WLAN 30 is successful, reset and (re-)start the timer. The UE 100 may, if an ACK is received from the AP 300 (or the WT 600), determine that the transmission of data via the WLAN 30 is successful. The UE 100 may be configured with a setting value of the timer (the threshold value of the delay time) by the eNB 200. The eNB 200 may transmit, to the UE 100, a setting value of the timer by an individual signal (for example, the RRC Connection Reconfiguration), or a common signal (for example, SIB: System Information Block). The eNB 200 may include a setting value of the timer into the configuration information of the LWA.

The UE 100 may, in accordance with the reception status of data via the WLAN 30 in the UE 100, determine whether or not to execute the process in step S204. The UE 100 may, similarly to the eNB 200 in the first embodiment, execute the process in step S204 if the WLAN data from the eNB 200 in the downlink is delayed. The UE 100 may, in a case that the same frequency is utilized in the uplink and the downlink (TDD: Time Division Duplex TDD), determine whether or not to execute the process in step S204, in accordance with the reception status of the WLAN data from the eNB 200 in the downlink.

The UE 100 may, in accordance with the transmission status of data via the WLAN that is sent by the WLAN entity of the UE 100 (via the LWAAP entity of the UE 100) to the PDCP of the UE 100, determine whether or not to execute the process in step S204. The WLAN entity of the UE 100 may send, to the PDCP of the UE 100, a successful delivery indication indicating that the transmission of data via the WLAN was successful, as the transmission status of the data via the WLAN. The UE 100 may, in accordance with the reception status of the successful delivery indication in the PDCP of the UE 100, determine whether or not to execute the process in step S204.

The LWAAP entity of the UE 100 may send, to the PDCP of the UE 100, the transmission status of data via the WLAN.

In step S204, the UE 100 can transmit, to the eNB 200, a buffer status report (BSR) in the PDCP. Therefore, the BSR is triggered in accordance with the communication status of the WLAN data (the transmission status and/or the reception status).

When the UE 100 transmits the data only via the WLAN 30, the PDCP of the UE 100 notifies the MAC of the UE 100 that the buffer amount (buffer status: BS) is zero. The PDCP of the UE 100, in accordance with the communication status of the WLAN data, updates the amount of data (BS) to be transmitted via the LTE, and notifies the MAC of the UE 100. The UE 100 may transmit, to the eNB 200, a BSR based on the updated BS.

The UE 100 may, even if a BSR has already been transmitted to the eNB 200, transmit, to the eNB 200, a BSR indicating a BS that is updated in accordance with the communication status of the WLAN data.

The eNB 200 may, in response to the reception of the BSR, determine a delay in the WLAN data.

In step S205, the UE 100 may execute a control for transmitting, to the eNB 200, the communication status of the WLAN data (the transmission status and/or the reception status). For example, the UE 100 may transmit a PDCP status report to the eNB 200. The UE 100 may receive, from the eNB 200, trigger information of the PDCP status report. The eNB 200 may transmit the trigger information to the UE 100. The trigger information may be, for example, information indicating the total number of unreceived data (packets) of the WLAN data. The UE 100 may, if the total number of unreceived data of the WLAN data exceeds a threshold value, transmit the communication status of the WLAN data. The trigger information may be information (threshold value) about a difference between the maximum SN value of the LTE data that was successfully transmitted and the maximum SN value of the WLAN data that was successfully transmitted. The UE 100 may, if a difference between the maximum SN value of the LTE data that was successfully transmitted and the maximum SN value of the WLAN data that was successfully transmitted exceeds a threshold value, transmit the communication status of the WLAN data.

The trigger information may be applied to the BSR transmission in step S204.

The UE 100 may execute the process in step S205 instead of sending the BSR in step S204. The UE 100 may not execute the process in step S204.

In step S206, the eNB 200 allocates a radio resource to the UE 100 based on the BSR.

In step S207, the UE 100 can transmit data via the LTE by using the radio resource allocated from the eNB 200. The UE 100 may execute a control for transmitting the data by using only a radio resource of the eNB 200 without transmitting the data via the WLAN 30 until a predetermined time elapses.

From the above, if an LWA operation is being executed, the UE 100 can decide the transmission path of the data in accordance with the communication status of the WLAN data. As a result, the occurrence of HFN non-synchronization can be restrained while effectively utilizing resources.

### Third Embodiment

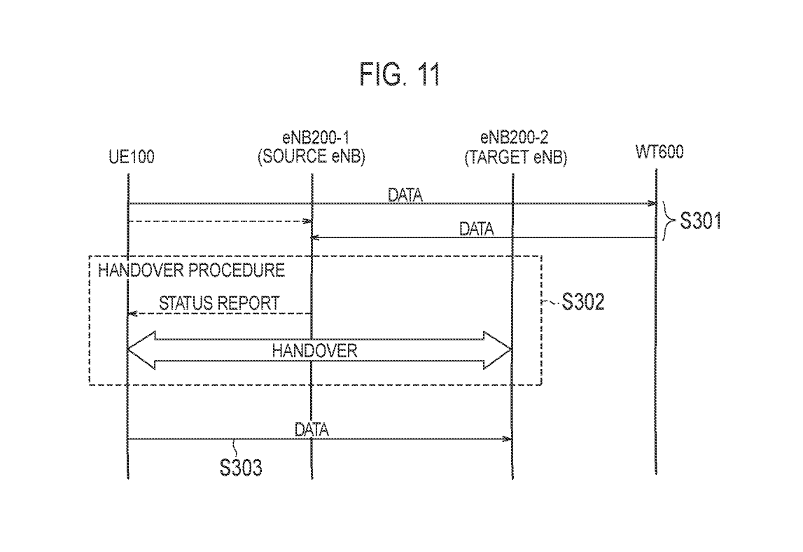

An operation according to a third embodiment will be described by using FIG. 8 and FIG. 11. FIG. 11 is a sequence diagram for describing an operation according to the third embodiment. It should be noted that the description of portions similar to those in each of the above-described embodiments will be omitted.

In the third embodiment, a case in which the UE 100 executes a handover when an LWA operation is being executed will be described.

In FIG. 11, the UE 100 camps on a first cell managed by an eNB 200-1. An eNB 200-2 is adjacent to the eNB 200-1. The eNB 200-2 manages a second cell. The second cell is adjacent to the first cell.

Step S301 corresponds to step S101. The UE 100 transmits data to the eNB 200 via the WLAN 30 (and via the LTE).

In step S302, a handover procedure is executed. The UE 100 executes a control for executing a handover from the first cell (the eNB 200-1: Source eNB) to the second cell (the eNB 200-2: Target eNB).

The eNB 200-1 may, in the handover procedure, similarly to in step S202, inform the UE 100 of the reception status of data via the WLAN 30 (the WLAN reception status) in the eNB 200-1. The eNB 200-1 can, before the UE 100 executes a handover to the eNB 200-2, inform the UE 100 of the WLAN reception status. That is, the eNB 200-1, before the communication with the UE 100 is disabled due to the handover, informs the UE 100 (of the WLAN reception status).

The eNB 200-1 may, in response to the decision for a handover, inform the UE 100 of the WLAN reception status. The eNB 200-1 may, in response to transmission of a handover request message, inform the UE 100 of the WLAN reception status. The eNB 200-1 may, in response to the transmission of a handover request acknowledgement message (Handover Request Ack), inform the UE 100 of the WLAN reception status. The eNB 200-1 may include the WLAN reception status into the allocation of radio resources to be transmitted to the UE 100 in response to reception of the handover request acknowledgement message. The eNB 200-1 may include the WLAN reception status into an RRC connection reconfiguration message resource to be transmitted to the UE 100 in response to the reception of the handover request acknowledgement message.

Thereafter, the handover procedure is completed.

In step S303, the UE 100, before transmitting the data, decides the data to be transmitted to the second cell (the eNB 200-2). The UE 100 may decide not only data that has not been transmitted yet, but also data that has already been transmitted as the data to be transmitted.

The UE 100 may, in accordance with the WLAN reception status received from the eNB 200, decide the data to be transmitted to the second cell. That is, the UE 100 may, of the data that has already been transmitted, decide to transmit (re-transmit) WLAN data that the eNB 200 has not received.

The UE 100 may, in accordance with the transmission status of data via the WLAN that is sent by the WLAN entity of the UE 100 (via the LWAAP entity of the UE 100) to the PDCP of the UE 100, decide the data to be transmitted to the second cell. That is, the UE 100 may decide to transmit (re-transmit) the WLAN data that was not successfully transmitted in the WLAN entity of the UE 100. The UE 100 may determine the transmission status of the data via the WLAN, base on, for example, the successful delivery indication described above.

The UE 100 can transmit (re-transmit) the decided data to the eNB 200-2.

Thus, the UE 100 can avoid transmitting, to the eNB 200-2, the data (packet) of which the transmission to the eNB 200-1 has been completed. Regardless of whether the eNB 200-1 has not received a packet, the UE 100 can avoid a case where an unreceived packet is not transmitted to the eNB 200-2.

### Fourth Embodiment

An operation according to a fourth embodiment will be described by using FIG. 8. It should be noted that the description of portions similar to those in each of the above-described embodiments will be omitted.

In the fourth embodiment, a packet to be sent through the LWA includes information about the transmission time.

The UE 100 executes a control for transmitting a first data (first packet) via one of the LTE and the WLAN 30, and transmitting a second data (second packet) following the first data via the other one of the LTE and the WLAN 30. In this case, the second data includes information about the transmission time of the second data.

For example, the UE 100 transmits the first packet (SN=x) to the eNB 200 via the LTE. The UE 100, in a case of transmitting the second packet (SN=x+1) to the eNB 200 via the WLAN 30, includes information about the transmission time of the second packet into the second packet.

The information about the transmission time may be a time (time stamp) when the UE 100 transmits the second packet. The information about the transmission time may be a time (time stamp) when the PDCP of the UE 100 sends the second packet to a low-level entity (for example, the LWAAP entity of the UE 100, the WLAN entity of the UE 100, or the like).

The information about the transmission time may be information about a time (difference) from when the first packet is transmitted until when the second packet is transmitted.

The UE 100 may also execute the same process in a case when the first packet (SN=x) is transmitted to the eNB 200 via the WLAN 30, and the second packet (SN=x+1) is transmitted to the eNB 200 via the LTE.

The UE 100 may include the information about the transmission time into the second packet only in a case that the transmission path of the data is switched.

As a result, the eNB 200 can, based on the information about the transmission time, acquire the communication status of the WLAN data.

The eNB 200 may execute the same process as the UE 100. As a result, the UE 100 can acquire the communication status of the WLAN data. The UE 100 may, based on the acquired communication status of the WLAN data, execute the operation according to each of the embodiments described above.

### Fifth Embodiment

An operation according to a fifth embodiment will be described by using FIG. 8. It should be noted that the description of portions similar to those in each of the above-described embodiments will be omitted.

According to the fifth embodiment, the transmission path of the data is switched based on the transmission data amount of the UE 100 in the LWA.

In FIG. 8, the UE 100 can, if an amount of transmission data in a PDCP entity of the UE 100 is below a first threshold value, execute a control for transmitting the data only via one of the LTE and the WLAN 30.

For example, the PDCP of the UE 100 may, if an amount of transmission data is below the first threshold value, send the data (via the LWAAP entity of the UE 100) only to the WLAN entity of the UE 100 based on the configuration from the eNB 200. Accordingly, the UE 100, if the transmission direction of the data is the WLAN 30, and if the amount of the transmission data is below the first threshold value, may not need to transmit the data to the eNB 200 (LTE).

The PDCP of the UE 100 may, if the amount of the transmission data is below the first threshold value, send the data only to the LTE entity of the UE 100. Accordingly, the UE 100, if the transmission direction of the data is the LTE, and if the amount of the transmission data is below the first threshold value, may not need to transmit the data to the WLAN 30.

Thus, since the UE 100 uses only one entity (the WLAN entity or the LTE entity), the processing load can be reduced. As a result, the power consumption of the UE 100 can be reduced.

The UE 100 can, if the amount of the transmission data is equal to or more than the first threshold value, execute a control for transmitting the data via both the LTE and the WLAN 30, based on the configuration from the eNB 200.

For example, the UE 100 can, if the amount of the transmission data is equal to or more than the first threshold value, transmit the data not only via the WLAN 30, but also via the LTE even if the transmission direction of the data is configured as the WLAN 30. The UE 100 can, if the amount of the transmission data is equal to or more than the first threshold value, transmit the data not only via the LTE, but also via the WLAN 30 even if the transmission direction of the data is configured as the LTE.

The first threshold value may be configured by the eNB 200. The first threshold value may be configured for each bearer.

The UE 100 may, in a case that the data is transmitted only via the WLAN 30, execute a control for informing the MAC of the UE 100 that the data does not exist in the PDCP even though the data exists in the PDCP. Accordingly, the PDCP of the UE 100 may notify the MAC of the UE 100 that the buffer amount (buffer status: BS) is zero. Therefore, the UE 100 may, in a case that the data is transmitted only via the WLAN 30, that is, in a case that the transmission direction of the data is configured as the WLAN 30, skip the transmission of the BSR to the eNB 200. The UE 100 may, if the transmission direction of the data is configured as the WLAN 30, and a buffer amount (the amount of the transmission data) is below a first threshold value, skip the transmission of the BSR to the eNB 200. The UE 100 may, even if a BSR is triggered (the BSR trigger condition is met), skip the transmission of the BSR. For example, the UE 100 may skip the cyclic transmission of the BSR. As a result, an unnecessary signaling can be reduced.

The UE 100 may, if the transmission direction of the data is configured as the WLAN 30, and the buffer amount (the amount of the transmission data) is equal to or more than the first threshold value, transmit the BSR to the eNB 200 (or start the transmission of the BSR). The UE 100 may, if the transmission direction of the data is configured as the WLAN 30, and the buffer amount (the amount of the transmission data) is equal to or more than the first threshold value, determine that the BSR to the eNB 200 has been triggered (or the trigger condition has been met). The eNB 200 may, based on the BSR from the UE 100, allocate, to the UE 100, a radio resource for transmitting data via the LTE.

The UE 100 may, in a case that the data is transmitted only via the LTE, execute a control for informing the WLAN entity of the UE 100 (or the LWAAP entity of the UE 100) that the data does not exist in the PDCP even though the data exists in the PDCP. The LWAAP entity of the UE 100 may inform that data does not exist in the PDCP (LWAAP). Accordingly, the PDCP of the UE 100 may notify the WLAN entity of the UE 100 (via the LWAAP entity of the UE 100) that the buffer amount (Buffer status: BS) is zero. Alternatively, the UE 100 may, in a case that data is transmitted only via the LTE, skip the notification to the WLAN entity of the UE 100 (or the LWAAP entity of the UE 100).

Thus, the UE 100 can, if the amount of the transmission data is small (the amount of the transmission data is below the first threshold value), prevent a time delay due to an order maintenance process at the receiving side (eNB 200). Furthermore, the processing load of the eNB 200 can be reduced. On the other hand, if the amount of the transmission data is equal to or more than the first threshold value, the resources of the eNB 200 and the WLAN can be effectively utilized.

### Modification of Fifth Embodiment

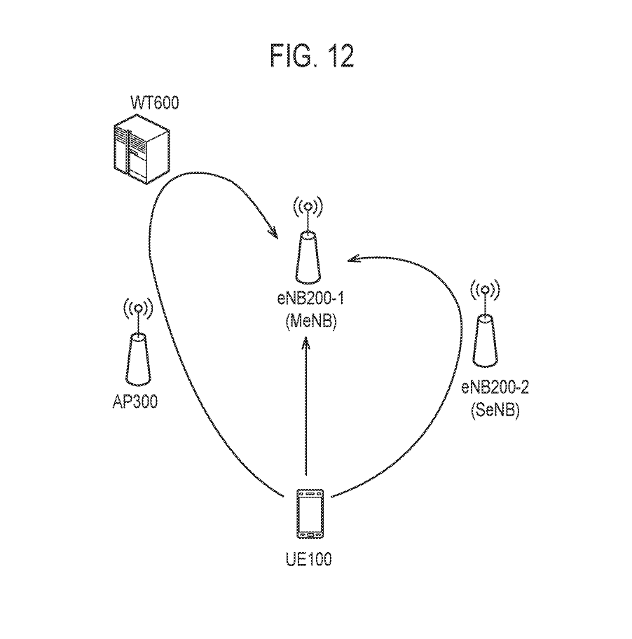

Next, an operation according to a modification of the fifth embodiment will be described by using FIG. 8 and FIG. 12. FIG. 12 is a diagram for describing an operation according to a modification of the fifth embodiment. It should be noted that the description of portions similar to those in each of the above-described embodiments will be omitted.

In the modification of the fifth embodiment, LWA and DC (Dual Connectivity) are executed.

In FIG. 12, the LWA and the DC are configured for the UE 100 by the eNB 200. A split bearer in the DC is configured for the UE 100. The split bearer is a bearer in which a radio protocol is located in both the MeNB and the SeNB to use resources of the MeNB (eNB 200-1) and the SeNB (eNB 200-2), in the DC.

Accordingly, the UE 100 transmits data to at least one of the eNB 200-1 and the eNB 200-2. The eNB 200-2 sends (transfers) the data from the UE 100 to the eNB 200-1.

The DC is an operating mode of the UE 100 in the RRC connected state, in which a master cell group (MCG) and a secondary cell group (SCG) are set. The master cell group is a group of serving cells associated with the MeNB in the DC, and is made up of a PCell and optionally of one or more SCells. The secondary cell group is a group of serving cells associated with the SeNB, and is made up of a PSCell and optionally of one or more SCells. The SeNB is the eNB (eNB 200-2), which provides an additional radio resource for the UE 100 in the DC, but is not the MeNB.

The UE 100, as described above, transmits data to the eNB 200-1 via at least one of the LTE and the WLAN 30 through the LWA.

In this case, the UE 100 controls the transmission of data by using not only the first threshold value described above, but also the second threshold value.

The UE 100 can, if the amount of the transmission data in the PDCP entity of the UE 100 is below the second threshold value, execute a control for transmitting the data only to one of the eNB 200-1 and the eNB 200-2.

For example, the PDCP of the UE 100, if the amount of the transmission data is below the second threshold value, sends the data (via the LWAAP entity of the UE 100) only to the WLAN entity of the UE 100, based on the configuration from the eNB 200-1. Alternatively, the PDCP of the UE 100, if the amount of the transmission data is below the first threshold value, sends the data only to the LTE entity of the UE 100.

The UE 100 can, if the amount of the transmission data is equal to or above the second threshold value, execute a control for transmitting the data to only one of the eNB 200-1 and the eNB 200-2, based on the configuration from the eNB 200.

If “Transmission data amount>First threshold value (LWA)>Second threshold value (DC)” or “Transmission data amount>Second threshold value (DC)>First threshold value (LWA)” is satisfied, the UE 100 can send the data via the LTE and via the WLAN 30. The UE 100 can send the data by using radio resources of both the eNB 200-1 (MCG) and the eNB 200-2 (SCG).

If “First threshold value (LWA)>Transmission data amount>Second threshold value (DC)” is satisfied, the UE 100 can send the data only via the WLAN 30. Alternatively, the UE 100 can, in a case that the data is sent only via the LTE, send the data by using the radio resources of both the eNB 200-1 (MCG) and the eNB 200-2 (SCG).

If “First threshold value (LWA)>Second threshold value (DC)>Transmission data amount” or “Second threshold value (DC)>Transmission data amount>First threshold value (LWA)” is satisfied, the UE 100 can send the data only via the WLAN 30. Alternatively, the UE 100 can, in a case that the data is sent only via the LTE, send the data by using only the radio resources of one of the eNB 200-1 (MCG) and the eNB 200-2 (SCG).

If “Second threshold value (DC)>Transmission data amount>First threshold value (LWA)” is satisfied, the UE 100 can send the data via the LTE and via the WLAN 30. The UE 100 can, in a case that the data is sent via the LTE, send the data by using only radio resources of one of the eNB 200-1 (MCG) and the eNB 200-2 (SCG).

The second threshold value may be configured by the eNB 200. The second threshold value may be configured for each bearer. Therefore, the first threshold value and the second threshold value may be configured for the same bearer.

The UE 100 can utilize the resources of the eNB 200 and the WLAN more effectively by controlling the transmission of data by using not only the first threshold value described above, but also the second threshold value.

### OTHER EMBODIMENTS

The contents of the present application are described according to each of the above-described embodiments, but it should not be understood that the discussion and the drawings constituting a part of this disclosure limit the contents of the present application. From this disclosure, various alternative embodiments, examples, and operational technologies will become apparent to those skilled in the art.

In each of the above-described embodiments, a case in which data via the WLAN 30 was sent between the eNB 200 and the WT 600 via the Xw interface in the LWA (so-called, non-collocated scenario) was described. However, even in a collocated scenario, an operation similar to that described above may be executed. In the collocated scenario, the eNB 200 can transmit and/or receive the data of the UE 100 by using a radio resource of the WLAN 30. A WLAN function is provided in the eNB 200. Accordingly, the eNB 200 can execute the operation of the AP 300 (or the WT 600).

In each of the above-described embodiments, the LWAAP entity was present in the UE 100, but the present application is not limited thereto. The LWAAP entity may not be present in the UE 100. The function of the LWAAP entity may be possessed by another entity. The PDCP entity and the WLAN entity of the UE 100 (for example, WLAN MAC) may exchange data via the LWAAP entity. The PDCP entity and the WLAN entity of the UE 100 (for example, WLAN MAC) may directly exchange the data without going through the LWAAP entity.

In each of the above-described embodiments (for example, the fifth embodiment), the PDCP of the UE 100 may inform the WLAN entity of the UE 100 of an actual buffer amount.

For example, the PDCP of the UE 100 may, in a case that the BSR to the eNB 200-1 has been triggered, notify the WLAN entity of the UE 100 of the BS. That is, when the UE 100 transmits a BSR to the eNB 200, the PDCP of the UE 100 may notify the WLAN entity of the UE 100 of the BS.

The PDCP of the UE 100 may, in response to an inquiry from the WLAN entity, notify the WLAN entity of the UE 100 of the BS. The PDCP of the UE 100 may, in response to an inquiry from the LWAAP entity, notify the WLAN entity of the UE 100 of the BS.

The PDCP of the UE 100 may, only in a case that the transmission direction of the data is configured as the WLAN 30, notify the WLAN entity of the UE 100 of the BS. The PDCP of the UE 100 may, only in a case that the amount of the transmission data is equal to or more than the first threshold value, notify the WLAN entity of the UE 100 of the BS. That is, the UE 100 may, only in a case that data is transmitted or is likely to be transmitted via the WLAN 30, notify the WLAN entity of the UE 100 of the BS. Therefore, the UE 100 does not, in a case that the data is not likely to be transmitted or is not transmitted via the WLAN 300 (that is, the data is transmitted only via the LTE), notify the WLAN entity of the UE 100 of the BS.

The WLAN entity can be decide an appropriate transmission scheme, based on the BS. For example, the WLAN entity of the UE 100 may notify the WLAN entity at the network side of the information about the transmission data amount. The information about the transmission data amount includes first transmission data amount buffered in the WLAN entity of the UE 100 (for example, the WLAN MAC entity), and second transmission data amount indicated by the BS. The information about the transmission data amount may include a value in which the first transmission data amount and the second transmission data amount are added. The WLAN entity at the network side may, based on the information about the transmission data amount, perform scheduling of the radio resources, the modulation scheme, the coding rate, etc. that the UE 100 (the WLAN entity) uses in the transmission.

The WLAN entity at the network side may be a WLAN entity in the WT 600. The WLAN entity at the network side may be a WLAN entity in the AP 300.

The operation according to each of the above-described embodiments may be combined to be executed, where necessary. In each of the above-described embodiments, although the operations of the UE 100, the eNB 200, and the WT 600 are described using the series of sequences, only a part of the operations may be executed, so that all the operations may not be executed.

Although not particularly mentioned in each of the above-described embodiments, a program for causing a computer to execute each process executed by each of the above-described nodes (such as the UE 100, the eNB 200, the AP 300, and the WT 600) may be provided. The program may be recorded on a computer-readable medium. If the computer-readable medium is used, it is possible to install the program on a computer. Here, the computer-readable medium recording therein the program may be a non-transitory recording medium. The non-transitory recording medium may include, but not be limited to, a recording medium such as a CD-ROM and a DVD-ROM, for example.

Alternatively, a chip may be provided which is configured by: a memory configured to store a program for executing each process executed by any one of the UE 100, the eNB 200, and the WT 600; and a processor configured to run the program stored in the memory.

In each of the above-described embodiments, as one example of a mobile communication system, the LTE system is described; however, the contents of the present disclosure are not limited to the LTE system. The contents of the present disclosure may be applied to systems other than the LTE system.

### Supplementary Note

### (A) Supplementary Note 1

(A1) Introduction

One of the objectives of the approved eLWA (enhanced LWA) WI (Work Item) is to enable uplink data transmission for LWA without changing LWA architecture. This supplementary note discusses how uplink transmission may be achieved.

(A2) Discussion

The existing LWA are based on many of the dual connectivity solutions. Since uplink transmission for dual connectivity is already specified in Rel-13, RAN2 also has the opportunity to reuse the solutions for eLWA.

Proposal 1: For uplink transmission in enhancement LWA, RAN2 should reuse solutions for dual connectivity.

(A 2.1) Split Bearer

(A 2.1.1) Threshold

Dual connectivity enhancement in Rel-13 introduces threshold for uplink split bearer. This threshold is used by UE to evaluate whether the data amount for transmission is large or small. If the data amount is larger than the configured threshold at the time of UL grant reception, UE can transmit data to both MCG and SCG. If the data amount is small, the UE can transmit the data toward the configured CG (MCG or SCG). This mechanism for data transmission should also be considered for eLWA.

In the existing specification, the threshold is configured per radio bearer in RRC. It may be possible to reuse the message for eLWA.

Proposal 2: Threshold should be applicable for uplink transmission in enhanced LWA.

The direction, which UE sends data when the data amount is smaller than the threshold, should be controllable by NW if proposal 2 is agreeable. This is achievable e.g. by introducing ul-DataSplitDRB-ViaWLAN as dual connectivity.

Proposal 3: The direction, which UE sends data when the data amount is smaller than the threshold, should be controllable by NW.

According to current PDCP specification, UE shall indicate data amount available for transmission to LTE-MAC entity or entities. When the data amount becomes smaller than the threshold, the UE shall indicate the amount data as 0 to one of the LTE-MAC entities which is not configured to be sent. The main purpose of this indication is BSR triggering and Buffer Size calculation. Although it is not crystal clear how the indication is used by WLAN, indicating arrival data size is likely beneficial. Furthermore, masking the data amount (i.e., indicating data as 0) with threshold mechanism may be useful for controlling transmission direction.

Proposal 4: It should Discuss Whether the IEEE MAC Layer should Know the Data Available for Transmission.

Proposal 5: It should discuss whether the UE shall indicate data available as 0 towards the IEEE MAC If the data amount is small and the transmission direction is configured to be sent to LTE.

(A2.1.2) Successful Delivery of PDCP PDUs

According to the PDCP specification, there is a NOTE that “when e.g., the PDCP SDUs are discarded or transmitted without acknowledgement, may cause HFN desynchronization problem” for uplink transmission.

However it is not clear whether any of the WLAN specification supports such indication or not. There are two alternatives for the UE to know the successful delivery.

Alternative 1: UE confirms the successful delivery via WLAN by itself.

Alternative 2: eNB sends feedback via LTE.

For achieving alternative 1, a possible way is that IEEE makes sure that WLAN indicate the successful delivery of each packet. Another way for alternative 1 is that UE (LWAAP) just monitors WLAN behaviour without changing IEEE specification while this is uncertain way.

Alternative 2 is easier to specify than alternative 1 since collaboration with other groups such as IEEE is not needed. But the drawback of this alternative is the increase in signalling overhead.

Proposal 6: It should discuss how UE recognizes successful delivery of each PDCP PDU via WLAN.

(A2.2) Switch Bearer

One of the objectives for this WI is to specify uplink switch bearer.

In Rel-13 LWA, the direction for data transmission is up to the NW since switch bearer operation is achievable by NW implementation without UE configuration. However for uplink transmission, UE cannot understand whether the NW expects that the data to be delivered via WLAN only or to both LTE and WLAN. To ensure the UE will send uplink data via WLAN only, it is necessary for the NW to configure the direction. There are options to go with either explicit or implicit configurations as follows.

Explicit configuration: eNB configures the UE with new bearer type e.g. drb-TypeSwitchLWA.

Implicit configuration: eNB configures the UE with infinity (or large enough) threshold for the LWA split bearer.

If the threshold mechanism is introduced for uplink LWA transmission, configuration of switch bearer without introducing new drb-type is achievable. Since the data amount is never larger than the infinite threshold, data direction is always limited to one direction (WLAN). This is equal to switch bearer configuration.

Whichever RAN2 selects explicit or implicit configuration, it works. Firstly, RAN2 should agree that the configuration is needed for switch bearer.

Proposal 7: For making sure that the UE can send uplink data via WLAN only, eNB should configure the data direction for switched bearers.

(A3) Annex (Potential Issue)

Push/Pull

In LTE, pull model is assumed in dual connectivity while push model is a baseline for WLAN.

Pull model means that packet is delivered upon request from lower layers. This is described in [2] that “When submitting PDCP PDUs to lower layers upon request from lower layers,”.

On the other hand, WLAN is basically scheduling-less system, i.e., the IP layer onto the IEEE MAC does not indicate any “data available for transmission” and it's still applicable even to the advanced WLAN, considering its protocol stack. A model like the “Push” is assumed for WLAN, wherein the IEEE MAC starts the preparation of transmission only when the PDU (packet) comes.

There are some ways to think about this e.g.
Considering how to push the PDCP PDU to WLAN MAC
Change IEEE spec to send “request” to upper layer
Just removing “upon request from lower layers” for making everything unclear (relying on UE implementation)

Anyway enhancements for LWAAP may be needed.

(Autonomous Re-Routing)

RAN2 needs to decide whether BSR towards LTE is disallowed whenever Switched bearer (WLAN as the direction) is configured. For example, when the UL data is stacked, some mechanism is necessary, before the UL path is recovered, i.e., to be reconfigured towards LTE.) This way is also applicable for exceptional case in split bearer configuration.

It can be assumed that the UE has to report such W-RLF to the MCG and subsequently the MCG can allocate UL resources to the UE. Or perhaps the UE can autonomously send the BSR to the MCG (even though it wasn't supposed to), but this would be an implicit indication to the MCG that UE has experienced W-RLF.

### (B) Supplementary Note 2

(B1) Introduction

One of the objectives of the eLWA WI is to enable the uplink data transmission over LWA bearers without changing the current LWA architecture. This supplementary note further discusses how uplink transmission may be achieved.

(B2) Discussion

The existing LWA is based on many of the dual connectivity solutions, e.g., the split bearer at PDCP layer. Since the uplink transmission for dual connectivity is already specified in Rel-13, RAN2 also has the opportunity to reuse the solutions for eLWA.

Proposal 1: For the uplink transmission in enhancement LWA, it should reuse solutions for dual connectivity as much as possible.

(B 2.1) Split LWA bearer

(B 2.1.1) Threshold

The dual connectivity enhancement in Rel-13 introduces the threshold for the uplink split bearer, whereby this threshold is used by UE to evaluate whether the data amount for transmission is large or small. If the data amount is larger than the configured threshold, the UE sends BSR to both MCG and SCG, i.e., the UE has the opportunity to transmit the data towards both CGs depending on reception of UL grants. Otherwise, the UE only sends BSR to the configured CG, thus it may transmit the data only toward a CG (either MCG or SCG). This mechanism for BSR trigger and data transmission should also be considered for eLWA.

For eLWA, it was agreed that “LTE buffer status information will not be reported over the WLAN link”, So, the double BSR like dual connectivity is no longer necessary. However, it is still worthwhile to retain a portion of the dual connectivity concept, such that a threshold could be used to limit unnecessary BSR towards LTE, e.g., when the direction is configured with WLAN and the data amount is smaller than the threshold, the UE does not need to send BSR towards LTE. In addition, it should also be possible to avoid unnecessary UE power consumption, e.g., when the direction is configured with LTE, the UE may not send the data towards WLAN as long as the data amount is smaller than the threshold.

In the existing specification for dual connectivity, the threshold is configured per a radio bearer basis in RRC. It may be possible to reuse the message for eLWA.

Proposal 2: The per-bearer threshold for BSR triggering and uplink transmission should be also applicable to enhanced LWA.

The direction, which the UE sends uplink data when the data amount is smaller than the threshold, should be controllable by the NW, if proposal 2 is agreeable. This is achievable e.g. by introducing ul-DataSplitDRB-ViaWLAN as dual connectivity.

Proposal 3: The direction, which the UE sends uplink data when the data amount is smaller than the threshold, should be controllable per a bearer basis and by the NW.

According to current PDCP specification, the UE shall indicate its data amount available for transmission to the LTE-MAC entity or entities. When the data amount becomes smaller than the threshold, the UE shall indicate the amount of data as 0 to one of the LTE-MAC entities which is not configured to be sent. The main purpose of this indication is BSR triggering and Buffer Size calculation. For eLWA, although it was already agreed that “LTE buffer status information will not be reported over the WLAN link”, it's still not crystal clear whether the IEEE MAC layer within the UE needs the buffer status information in its PDCP layer, since OFDMA will be supported in the up-to-date WLAN, i.e., 802.11ax. Since eLWA may need interactions between layers specified in different organizations, i.e., PDCP/LWAAP and WLAN MAC/PHY, the standard should take into account the interaction within the UE. We think it allows the flexibility from the UE implementation point of view.

Proposal 4: It should discuss whether the PDCP layer should inform the IEEE MAC layer of the data available for transmission within the UE.

Proposal 5: It should also discuss whether the PDCP layer should indicate the data available transmission as 0 towards the IEEE MAC within the UE, if the data amount is smaller than the threshold and the transmission direction is configured to be sent to LTE.

(B 2.1.2) Successful Delivery of PDCP PDUs

According to the PDCP specification, there is a NOTE that “when e.g., the PDCP SDUs are discarded or transmitted without acknowledgement, may cause HFN desynchronization problem” for the uplink transmission of dual connectivity.

However, it's not clear whether any of the WLAN specification supports such indication or not. There are two alternatives for the UE to know the successful delivery.

Alternative 1: The UE confirms the successful delivery via WLAN by itself.

Alternative 2: The eNB sends feedback via LTE.

To realize alternative 1, one of the possibilities is to have IEEE ensure that WLAN indicate the successful delivery of each packet. Another possibility is for the UE (LWAAP) to just monitor the WLAN behaviour without changing IEEE specification.

Alternative 2 has advantage over alternative 1 from a specification impact perspective since collaboration with other groups such as the IEEE is not needed. But the drawback of this alternative is the increased signalling overhead over the LTE Uu link.

Proposal 6: It should discuss how the UE recognizes successful delivery of each PDCP PDU via WLAN.

(B 2.2) Switched LWA Bearer

One of the objectives for this WI is to specify uplink switched LWA bearer. In Rel-13 LWA, the direction for downlink data transmission is up to the NW, since the equivalent switched bearer operation is achievable by NW implementations without any UE configuration. However, for uplink transmission, the UE may not understand whether the NW expects that the uplink data should be delivered via WLAN only or to both LTE and WLAN. To ensure the UE will send uplink data via WLAN only, it is necessary for the NW to configure the direction, explicitly or implicitly, as follows:

Explicit configuration: The eNB configures the UE with new bearer type e.g. drb-TypeSwitchLWA.

Implicit configuration: The eNB configures the UE with infinity (or large enough) threshold for the split LWA bearer.

If the threshold mechanism is introduced for uplink LWA transmission, the configuration of switched LWA bearer is achievable without introducing new drb-type. With infinite threshold, the amount of data will never exceed the threshold so the data direction is always limited to one direction (i.e., WLAN), even if it's configured with the split LWA bearer. This is equivalent to the use of switched LWA bearer configuration.

Regardless of which option RAN2 selects, the explicit or the implicit configurations the eNB will be able to control the data direction.

Proposal 7: To ensure the UE can be configured to send uplink data via WLAN only, either the implicit or explicit configuration should be adopted.

1. A communication method, comprising:
transmitting, by a base station in a Long Term Evolution (LTE) system, to a user equipment, configuration information configuring an LTE-Wireless Local Area Network (WLAN) Aggregation (LWA) bearer using both radio resources of the LTE system and radio resource of a WLAN system, the configuration information including first information indicating a threshold value for an amount of data;
configuring, by the user equipment, the LWA bearer based on the configuration information;
executing, by the user equipment, in response to an amount of data belonging to the LWA bearer being equal to or more than the threshold value, a first control for transmitting the data by using the radio resources of both the LTE system and the WLAN system; and
executing, by the user equipment, in response to the amount of data belonging to the LWA bearer being below the threshold value, a second control for transmitting the data by using the radio resource of either the LTE system or the WLAN system.

2. The communication method according to claim 1, wherein
executing the second control comprises determining, by the user equipment, based on second information included in the configuration information, which of the radio resource of the LTE system and the radio resource of the WLAN system is to be used.

3. The communication method according to claim 2, wherein
the user equipment has a PDCP entity and a Medium Access Control (MAC) entity,
executing the second control comprises:
in response to the user equipment determining to use the radio resource of the WLAN system, indicating by the PDCP entity to the MAC entity, that an amount of transmission data is zero.

4. The communication method according to claim 1, wherein
executing the first control comprises transmitting, by the user equipment to the base station, a buffer status report based on only a data amount to be transmitted to the LTE system out of the transmission data amount.

5. An apparatus that controls a user equipment, the apparatus comprising:
a processor and a memory coupled to the processor, the processor is configured to perform processes of:
receiving, from a base station in a Long Term Evolution (LTE) system, configuration information configuring an LTE-Wireless Local Area Network (WLAN) Aggregation (LWA) bearer using both radio resources of the LTE system and radio resource of a WLAN system, the configuration information including first information indicating a threshold value for an amount of data;
configuring the LWA bearer based on the configuration information;
in response to an amount of data belonging to the LWA bearer being equal to or more than the threshold value, executing a first control for transmitting the data by using the radio resources of both the LTE system and the WLAN system; and
in response to the amount of data belonging to the LWA bearer being below the threshold value, executing a second control for transmitting the data by using the radio resource of either the LTE system or the WLAN system.

6. A user equipment, comprising:
a processor and a memory coupled to the processor, the processor is configured to perform processes of:
receiving, from a base station in a Long Term Evolution (LTE) system, configuration information configuring an LTE-Wireless Local Area Network (WLAN) Aggregation (LWA) bearer using both radio resources of the LTE system and radio resource of a WLAN system, the configuration information including first information indicating a threshold value for an amount of data;
configuring the LWA bearer based on the configuration information;
in response to an amount of data belonging to the LWA bearer being equal to or more than the threshold value, executing a first control for transmitting the data by using the radio resources of both the LTE system and the WLAN system; and
in response to the amount of data belonging to the LWA bearer being below the threshold value, executing a second control for transmitting the data by using the radio resource of either the LTE system or the WLAN system.
